(19) United States
(12) Patent Application Publication
(10) Pub. No.: US 2009/0125656 A1
(43) Pub. Date: May 14, 2009

(54) Method and Arrangement for the Automatic Configuration of a Master-Slave Field Bus System

(76) Inventors: Siegfried Haas, St. Georgen (DE); Roland Ziegler, Dornhan (DE); Alexander Schontges, Rietheim-Weilheim (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/996,027

(22) PCT Filed: Jul. 19, 2006
(86) PCT No.: PCT/EP2006/064422

§ 371 Date: Jul. 22, 2008

(30) Foreign Application Priority Data
Jul. 22, 2005 (DE) 10 2005 034 944.7

(51) Int. Cl. G06F 13/00

(52) U.S. Cl. 710/104

(57) ABSTRACT

A field bus system (16), especially a LIN bus system, has a master (14) and at least one bus subscriber (15). In order to carry out an automatic configuration of the bus system, the master (14) stores the current configuration of the field bus system (16) as the known configuration, and carries out the following steps after restarting the bus system: a standard address is allocated as a subscriber address to the at least one bus subscriber (15); it is checked whether the at least one bus subscriber (15) belongs to the known configuration and, if this is the case, a unique subscriber address is allocated thereto (15); it is then checked whether the at least one bus subscriber (15) still has the standard address and, if this is the case, the at least one bus subscriber is identified and a unique subscriber address is allocated thereto.

### CROSS-REFERENCE TO RELATED APPLICATIONS

This application is a U.S. national stage application of International Application No. PCT/EP2006/064422 filed Jul. 19, 2006, which designates the United States of America, and claims priority to German application number 10 2005 034 944.7 filed Jul. 22, 2005, the contents of which are hereby incorporated by reference in their entirety.

### TECHNICAL FIELD

The invention relates to a method and an arrangement for automatically configuring a field bus system, particularly a LIN bus system, with a master and with at least one bus subscriber.

### BACKGROUND

Field bus systems are used particularly in industrial sectors, such as automation engineering, metrology and robotics, but are also used for networking controllers, sensors, actuators and also input and output means increasingly in means of transport, such as motor vehicles, aircraft and watercraft. Their fields of use mean that great demands in terms of robustness, handleability and maintainability are therefore placed on the field buses.

In a field bus system operating on the basis of the master/slave principle, the master initiates and coordinates any communication and the bus subscriber(s), that is to say the slaves, react to this. So that the master can specifically talk to, that is to say address, the at least one bus subscriber connected to the field bus, the bus subscriber needs to be assigned an explicit address or identification number which cannot be confused with any other bus subscriber, and this address or identification number needs to be disclosed to the master. This can be done before the field bus system is started up, by using configuration files to identify all bus subscribers present and allocating each bus subscriber an explicit subscriber address. The information from the configuration files are stored in a memory in the master, so that following a restart of the bus system the master already knows the subscriber addresses and can use them to communicate with the bus subscribers. In this way, the bus system is thus configured offline.

When configuring the bus system using information regarding the bus subscribers which is to be provided in advance, it is not possible to add new bus subscribers to the bus system without adjusting the configuration information and reprogramming the master. This sometimes requires a person skilled in the art to be called in, which makes the use of such a bus system inflexible and increases the complexity for system changes.

A field bus system which is configured using the procedure described is the LIN bus, which is used particularly in the automotive sector. In this context, the LIN bus is used not so much to network the whole vehicle as to link and combine subunits to form subsystems, for example in the case of display units in the area of the combination instrument or in the case of sensor and actuator elements in the door or roof area. Changing the number of bus subscribers means that the vehicle owner always needs to visit a workshop, which makes the retrofitting of desired supplementary appliances complex.

### SUMMARY

According to an embodiment, in a method and an arrangement for automatically configuring a field bus system, particularly a LIN bus system, with a master and at least one bus subscriber, the following steps may be initiated by the master:
step 0: storing the current configuration of the field bus system as a known configuration,
step 1: following a restart of the bus system, allocating a standard address as subscriber address to the at least one bus subscriber,
step 2: checking whether the at least one bus subscriber is part of the known configuration, and
step 3: if this is the case, allocating an explicit subscriber address to the at least one bus subscriber,
step 4: checking whether the at least one bus subscriber still has the standard address, and
step 5: if this is the case, identifying the at least one bus subscriber and allocating an explicit subscriber address to the at least one bus subscriber. Thus, the system or method can be used to add at least one new bus subscriber to the field bus system without the master knowing this at least one bus subscriber in advance.

According to a further embodiment, steps 1 to 5 may be performed for all respective bus subscribers present in the bus system. According to a further embodiment, steps 1 to 5 may be performed by sending at least one request to be answered in binary form to the at least one bus subscriber. According to a further embodiment, the request to be answered in binary form may be an instruction, linked to a condition, which is executed and at the same time answered positively by the at least one bus subscriber only if the condition is satisfied. According to a further embodiment, the request to be answered in binary form may be an address change request, linked to a condition, which, for the least one bus subscriber, results in allocation of a new subscriber address and in a positive response if the condition is satisfied. According to a further embodiment, the condition can be the presence of a particular identification feature in the at least one bus subscriber. According to a further embodiment, the condition or part of the condition may be the association between the at least one bus subscriber and a particular manufacturer and/or a particular function type. According to a further embodiment, in step 1 the at least one bus subscriber may be sent an address change request with which the standard address is transmitted as new subscriber address and whose condition is always satisfied by the at least one bus subscriber. According to a further embodiment, as steps 2 and 3 the at least one bus subscriber may be sent an address change request with which the explicit subscriber address is transmitted as new subscriber address and whose condition is the association between the at least one bus subscriber and a manufacturer and/or a function type, according to the known configuration. According to a further embodiment, the condition may be the presence of a particular identification feature in the at least one bus subscriber, and wherein as steps 2 and 3 the at least one bus subscriber may be sent an address change request with which the explicit subscriber address is transmitted as new subscriber address and whose condition is the presence of an explicit identification number, known before the restart, in the bus subscriber. According to a further embodiment, in step 4 the at least one bus subscriber may be sent an address change request whose condition is the presence of the standard address. According to a further embodiment, in step 5 the least one bus subscriber may be sent an address change request whose condition is the association between the at least one bus subscriber and a manufacturer which is possible in the bus system and/or a function type which is possible in the bus system. According to a further embodiment, with the address change request in step 5 or with a further address change request sent to the at least one bus subscriber only in the event of a positive response an explicit subscriber address may be sent as new subscriber address.

According to another embodiment, an arrangement for automatically configuring a bus system comprises a master and at least one bus subscriber which is connected to the master via a field bus, wherein the master and the least one bus subscriber are operable to perform the following steps initiated by the master:—step 0: storing the current configuration of the field bus system as a known configuration,—step 1: following a restart of the bus system, allocating a standard address as subscriber address to the at least one bus subscriber,—step 2: checking whether the at least one bus subscriber is part of the known configuration, and—step 3: if this is the case, allocating an explicit subscriber address to the at least one bus subscriber,—step 4: checking whether the at least one bus subscriber still has the standard address, and—step 5: if this is the case, identifying the at least one bus subscriber and allocating an explicit subscriber address to the at least one bus subscriber.

### BRIEF DESCRIPTION OF THE DRAWINGS

The invention is explained in more detail below with the aid of an exemplary embodiment and the drawing, in which:

FIG. 1 shows the message structure of an address change request;

FIG. 2 shows the message structure of a response to the request from FIG. 1;

FIG. 3 shows the message structure of another address change request;

FIG. 4 shows the message structure of a response to the request from FIG. 3;

FIG. 5 shows a LIN field bus system;

FIG. 6 shows a binary tree with the bus subscribers in the LIN field bus system;

FIG. 7 shows the operating cycle of steps 1 to 3;

FIG. 8 shows the operating cycle of steps 4 and 5.

### DETAILED DESCRIPTION

According to various embodiments, the master remembers the respective bus subscribers which are currently present in the field bus system and stores them as known bus subscribers. In addition, the master's programming is such that following a restart of the field bus system, which now comprises the master and the at least one bus subscriber, it performs the following method steps: allocating a standard address as subscriber address to the at least one bus subscriber, checking whether the at least one bus subscriber is one of the known configuration and, if this is the case, allocating an explicit subscriber address to the at least one bus subscriber, checking whether the at least one bus subscriber still has the standard address and, if this is the case, identifying the at least one bus subscriber and allocating an explicit subscriber address to the at least one bus subscriber.

In line with the arrangement according to various embodiments, the at least one bus subscriber is designed such that it can implement the master's messages for changing the subscriber address and can react to requests which are used to check the currently allocated address or to request information for identifying the respective bus subscriber.

The allocation of the standard address renders all bus subscribers addressable for the master, since it does not know their subscriber addresses, which it actually would have obtained from the configuration information, in advance. Only then is the master able to communicate with the bus subscribers. One or more identification requests to the bus subscriber(s) are used to check whether and which of the bus subscribers is already known to the master. The master then allocates the known bus subscribers a respective dedicated, explicit subscriber address and, if required, all further steps for fully configuring the respective bus subscriber are performed. The bus subscribers remaining with a standard address at the end of the check are therefore identified as new bus subscribers and are for their part specifically interrogated for identification features. When the respective new bus subscriber has been identified, this bus subscriber is also assigned an explicit subscriber address and the sometimes necessary further configuration steps are performed on it. Once all the bus subscribers present in the bus system have been provided with an explicit subscriber address, the configuration of the field bus system is complete. The master can then overwrite the known configuration with the information regarding the currently identified bus subscribers.

The method and the arrangement according to various embodiments allow one or else more new bus subscribers to be added to a field bus system operating on the basis of the master/slave principle, said new bus subscribers being configured by the master directly after the next restart without the master needing to be informed of these new bus subscribers in advance by means of a piece of configuration information. There is thus no need for the master to be reprogrammed. Furthermore, no additional hardware is required, but rather the solution can be implemented exclusively by means of software adjustments in the master and the at least one bus subscriber. In addition to the identification of just individual new bus subscribers, it is likewise possible to restart the field bus system with exclusively new bus subscribers, since in that case all bus subscribers are identified as new and are identified and then configured by means of appropriate requests.

The method according to various embodiments is preferably carried out in steps for all the bus subscribers which are present in the field bus system, that is to say that each of steps 1 to 5 is respectively first performed for all bus subscribers before proceeding to the next step. Alternatively, steps 1 to 5 may also be carried out directly in succession for each bus subscriber individually.

According to an embodiment, steps 1 to 5 are performed by sending at least one request to be answered in binary form to the at least one bus subscriber. In this context, a request to be answered in binary form is understood to mean a request which can be answered only with YES or NO, or TRUE or FALSE. In this case, the bus subscriber to which the request is made is either able to send both response types, that is say either the positive or the negative response depending on the situation, or can send just one of the two response types and leaves the request unanswered if the opposite response is obtained, which is accordingly interpreted as the opposite response.

The use of a binary request allows the bus subscribers to be logically associated with the individual leaves on a binary tree. Clever selection of the type of request allows the specific properties of the bus subscribers to be requested little by little and hence allows the latter to be identified, each request having an associated node in the binary tree. The bus subscribers always respond either with YES or NO and are assigned to the respective left or right child node of the node associated with the request, according to their response. If there is no child node then a leaf has been reached and hence a bus subscriber has been explicitly identified. In this way, it is possible both to look for the already known bus subscribers and to identify the new bus subscribers.

According to an embodiment, the request to be answered in binary form is an instruction, linked to a condition, which is executed and at the same time answered positively by the at least one bus subscriber only if the condition is satisfied. In this context, in one refinement, the condition requested is the presence of a particular identification feature in the at least one bus subscriber. The question of the condition being satisfied is thus used to prompt the YES/NO response by the bus subscriber and hence to run through the binary tree, while at the same time an instruction is executed by the bus subscriber when the condition is satisfied. This clever combination reduces the number of messages to be sent.

Instructions which are linked to a condition are known from the LIN bus standard. Thus, according to version 2.0 of the LIN bus standard, the master has the option of sending a message which results in a change to the subscriber address of just precisely that bus subscriber which satisfies one or more conditions transmitted with this message. Once a bus subscriber has then changed its subscriber address, it sends a positive response. A negative response simply fails to materialize and is interpreted by the master such that there is no bus subscriber in the bus system which satisfies the one or the plurality of conditions.

According to the LIN bus standard, such a condition may be the bus subscriber's association with a particular manufacturer and/or with a particular function type, that is to say that it is ascertained whether the bus subscriber has a particular manufacturer number and/or a particular function number in its identification features.

According to an embodiment, the address change requests known from LIN bus standard version 2.0 are used to identify bus subscribers in the known configuration, to filter out new bus subscribers and to assign the explicit subscriber addresses to all bus subscribers. In this case, the message type of the address change request linked to a condition affords the advantage that the steps of identifying a bus subscriber and assigning an explicit subscriber address are linked directly to one another, which reduces the number of requests and instructions to be sent. Furthermore, the use of the standardized address change requests ensures that a field bus system operating according to various embodiments also cannot have bus subscribers which do not operate on the basis thereof incorporated into it, these then needing to be disclosed to the master in advance in line with the conventional method.

In line with one refinement, in step 1 the at least one bus subscriber is sent an address change request with which the standard address is transmitted as new subscriber address and whose condition is always satisfied by the at least one bus subscriber. The condition is thus chosen such that all bus subscribers which are present and operate properly in the field bus system inevitably satisfy it so that the standard address is also certainly adopted by all bus subscribers.

In another refinement, as steps 2 and 3 the at least one bus subscriber is sent an address change request with which the explicit subscriber address is transmitted as new subscriber address and whose condition is the association between the at least one bus subscriber and a manufacturer and/or a function type, according to the known configuration.

As an alternative, it is proposed that the at least one bus subscriber be sent an address change request with which the explicit subscriber address is transmitted as new subscriber address and whose condition is the presence of an explicit identification number, known before the restart, in the bus subscriber.

In both refinements, the bus subscribers which are present and stored in the known configuration before the restart are specifically addressed using their identification features and, if the identification features match, are provided with a dedicated subscriber address. In this case, steps 2 and 3 are executed with a single message sent by the master.

In another refinement, in step 4 the at least one bus subscriber is sent an address change request whose condition is the presence of the standard address. This is preferably done by sending the address change request to bus subscribers with the standard address, so that only that or those bus subscriber(s) which still has/have the standard address respond(s) to the request in the positive. Bus subscribers to which a dedicated subscriber address has already been allocated and which accordingly belong to the known configuration do not receive the address change request at all. The address change request can again transmit the standard address as new subscriber address, that is to say that said standard address is simply overwritten with itself, or a changed unit address is transmitted.

In another refinement, in step 5 the at least one bus subscriber is sent an address change request whose condition is the association between the at least one bus subscriber and a manufacturer which is possible in the bus system and/or a function type which is possible in the bus system. For this, the master needs to know all bus subscriber types with their manufacturer and function numbers which may arise in the field bus system. The bus subscribers identified as new after the end of step 3 by means of the presence of the standard address are then interrogated as to their association with one of the fundamentally possible manufacturers and/or function types. The new subscriber address sent with the address change request is either an identification address which identifies the positively responding bus subscriber as being associated with a particular manufacturer and/or function type, or if the request results directly in an explicit identification then an explicit subscriber address is transmitted as accompaniment. If the identification is made using an identification address, the explicit subscriber address is transmitted to the bus subscriber only after the new bus subscriber has been explicitly associated with a manufacturer and a function type.

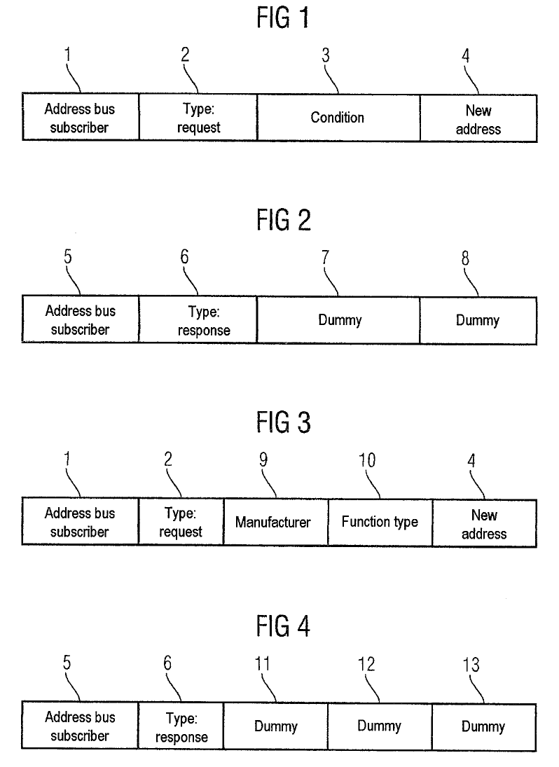

FIG. 1 shows the structure of an address change request which is sent by the master to a bus subscriber specified in the field 1 by means of its subscriber address and which is used to transmit a condition in field 3. In this case, the structure of the message corresponds to LIN bus standard version 2.0, the content of the individual fields being shown in simplified form. Field 2 defines the type of the message more precisely. In this example, which is reduced in comparison with the LIN bus standard, this is intended to be illustrated by the type “request”. Field 4 contains the new subscriber address to be transmitted with the address change request, said new subscriber address being adopted by the bus subscriber specified in field 1, provided that it satisfies the condition in the field.

If this is the case then the bus subscriber responds with a response message sent to the master as shown in FIG. 2. Field 5 of the response message contains the address of the responding bus subscriber, field 6 contains a message type, in this case the type “response”, and fields 7 and 8 contain prescribed dummy values, that is to say all bits set to 1, for example. By sending the response message, the bus subscriber reacts to the address change request positively and informs the master that it has adopted the new subscriber address. If no response is sent to the master, this is understood as a negative response.

FIG. 3 shows the schematized structure of an address change request based on LIN bus standard 2.0, which is used to transmit the association between the bus subscriber and a particular manufacturer (field 9) and between the bus subscriber and a particular function type (field 10) as a condition. The positive response to this request, shown in FIG. 4, corresponds to the response from FIG. 1, that is to say that fields 9 and 10 with the condition or conditions and field 4 with the new subscriber address are replaced by dummy values.

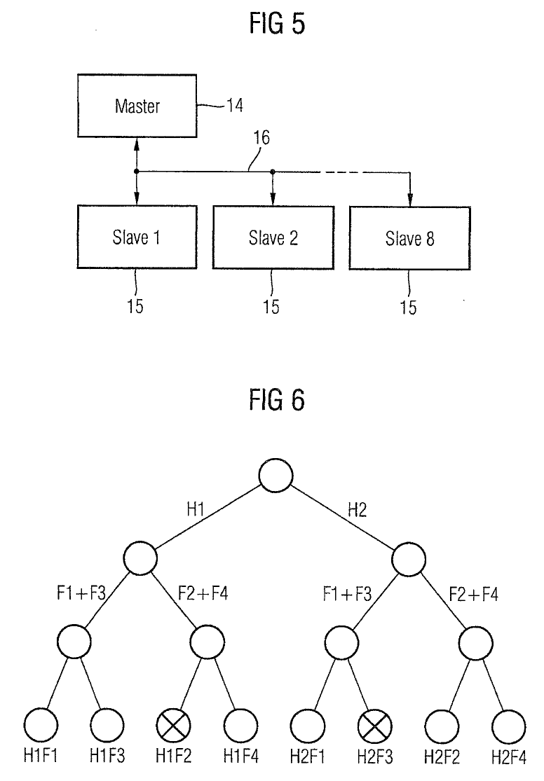

FIG. 5 shows an example of a LIN bus system in a vehicle, for example a motor vehicle or a sports boat, with a combination instrument as the master 14 and a total of eight pointer instruments as bus subscribers 15 (slaves). The LIN bus 16 connects the master 14 and the bus subscribers 15 to one another in the form of a star.

The eight bus subscribers 15 can be associated with the leaves 17 on a binary tree in line with the illustration in FIG. 6, since each pointer instrument can be explicitly associated with one of two manufacturers H1 and H2 and with one of four function groups F1 to F4. In this case, a function group is understood to mean the type of variable shown by the pointer instrument, for example, that is to say vehicle speed, engine temperature, engine speed and fuel level, for example. The tree starts from a root 18 and is divided at this root into a right and a left subtree, according to manufacturer H1 or H2. The two subtrees respectively start at a node 19 and are again divided into two respective subtrees, according to function type F1 and F3 or F2 and F4, which leads to the node 20.

In the subsequently described cycle of configuration of the LIN bus system from FIGS. 5 and 6, the bus subscribers H1F2 and H2F3 have been added as new bus subscribers. The master 14 has remembered the configuration, comprising the remaining six bus subscribers, as a known configuration, that is to say that it has stored in a memory at least that the function groups F1, F3 and F4 are present from the manufacturer H1 and the function groups F1, F2 and F4 are present from the manufacturer H2. Hence, step 0 of the method for configuration has already been performed and a restart can take place.

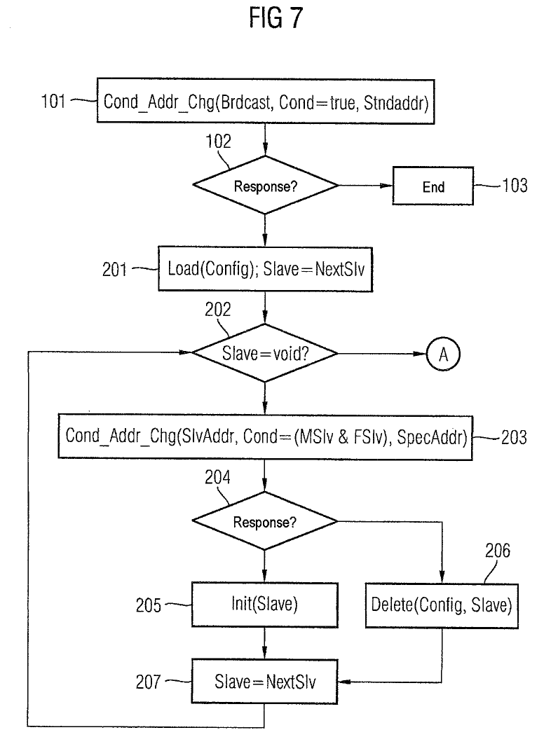

FIG. 7 is used to explain the execution of steps 1 to 3 carried out after the restart, which are subsequently referred to as primary steps. Primary step 1 includes substeps 101 to 103, with step 101 involving the master 14 sending the address change request Cond_Addr_Chg with the content shown in FIG. 1. The bus subscriber address used is what is known as a broadcast address, which is used to address all the bus subscribers 15 which are present in the bus system. The new subscriber address transferred is the standard address, and the condition is set to the value “true” from the outset, that is to say that the condition is always satisfied. In step 102, the master checks whether at least one bus subscriber 15 has sent a response. If this is not the case, no bus subscribers 15 are connected to the LIN bus and the configuration is therefore at an end (step 103). If there is at least one response, the process proceeds to primary step 2, which has the substeps 202 and 203. In step 202, the known configuration is loaded, i.e. the master fetches from the memory a list of bus subscribers present before the restart which have the associated identification features manufacturer and function type and start with the first list entry. In step 202, it checks whether the first list entry is already empty. If this is the case, no bus subscribers 15 were present before the restart, that is to say that all bus subscribers 15 in the bus system are new and are dealt with further by means of steps 4 and 5. These steps are entered via the junction point A.

When the first list entry is full, an address change request as shown in FIG. 3 is sent to the bus subscriber 15 entered therein. This request is thus sent to just one bus subscriber with the address “SlvAddr”, and it contains the condition that the receiver comes from the manufacturer “MSlv” and is of function type “FSlv”. At the same time, an explicit subscriber address “SpecAddr” is transmitted. If the bus subscriber responds in the positive, it has firstly been identified which bus subscriber from the known configuration continues to be present in the bus system, and also this bus subscriber has already been assigned an explicit subscriber address, that is to say that primary step 3 is also simultaneously performed with step 203. When a response is obtained and hence is positive (step 204), the further initialization of the bus subscriber can take place in step 205. If no response has been returned, the addressed bus subscriber is no longer present in the bus system and it can be deleted from the known configuration in step 206. In step 207, the next list entry is entered and the process resumes with step 202, that is to say that a check is performed to determine whether the list entry is empty. The loop continues to be executed until the end of the list with the known configuration is reached, that is to say until an empty list entry is reached. In the example shown in FIGS. 5 and 6, the six known bus subscribers 15 (H1F1, H1F3, H1F4, H2F1, H2F2 and H2F4) are then initialized at this point.

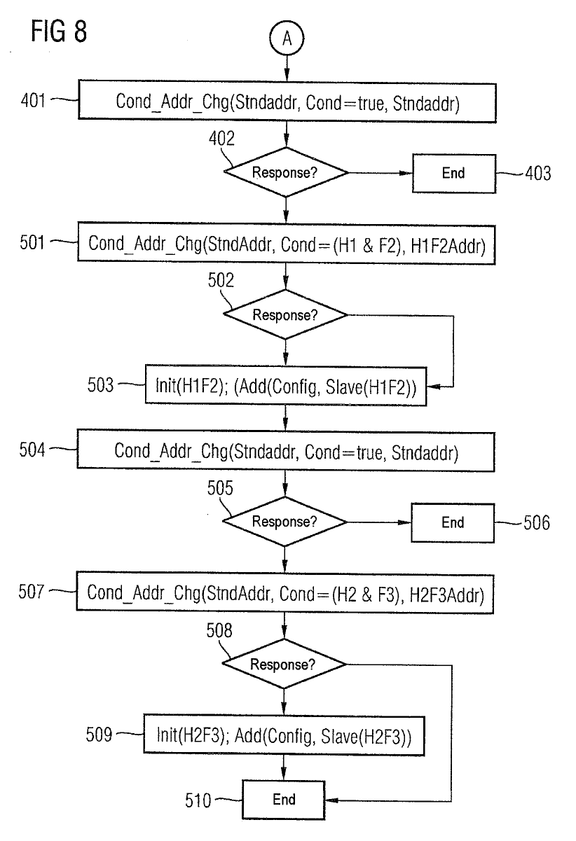

Junction point A is then used to change to primary steps 4 and 5, which are shown in FIG. 8. In primary step 4, with the substeps 401 to 403, a check is performed to determine whether bus subscribers with the standard address are present. For this, an address change request—shown in FIG. 1 is sent to the standard address, for which the condition is again set to “true”. The request is again used to send the standard address as new subscriber address. In the event of a positive response in step 402, it is certain that at least one bus subscriber with the standard address and hence a new bus subscriber is present. If no new bus subscribers are present, that is to say that the response does not appear, then the configuration of the bus system is at an end (step 403).

To configure the new bus subscriber(s), the master 14 then attempts to identify these bus subscribers. From the list with the known configuration, it knows that, in line with the binary tree, only leaves H1F2 and H2F3 are still unoccupied. It therefore addresses these leaves specifically. In step 501, at which primary step 5 starts, an address change request is sent to the standard address in line with FIG. 3, in which the condition is set to the manufacturer number H1 and the function number F2. As new subscriber address, the explicit subscriber address “H1F2Addr” is also transmitted. If a response is given, a new bus subscriber from manufacturer H1 and of function type F2 has been successfully identified, and at the same time an explicit subscriber address has been assigned to it. The new bus subscriber H1F2 is initialized in step 503 and is entered into the list of known configuration “Config”. The master 14 then again checks whether bus subscribers with the standard address are still present (steps 504, 505, 506). If this is the case then the last possible manufacturer and function type are subsequently checked. If the remaining new bus subscriber is from manufacturer H2 and of function type F3 (steps 507 and 508), it is assigned the explicit subscriber address “H2F3Addr” and it is initialized in step 509 and entered into the known configuration “Config”. Since no more than eight possible bus subscribers may be present in this example, the configuration of the bus system is therefore complete.

In cases in which more than eight bus subscribers may be present and in which not all leaves on the binary tree are occupied, the master cannot proceed as linearly as in FIG. 8, in particular, for reasons of computation time. It then makes its way along the binary tree by first checking whether one of the new bus subscribers belongs to the manufacturer H1, for example. This is again done using an address change request. If it does not receive a positive response, the master stores a note that there is no new bus subscriber present on the left node 19 and hence for manufacturer H1. The request then continues on the right subnode 20 with the address change request for the function types F1 and F3 or F2 and F4. In the case of larger binary trees, this step-by-step procedure within the binary tree simplifies the identification of the new bus subscribers.

What is claimed is:

1. A method for automatically configuring a field bus system, with a master and at least one bus subscriber, having the following steps initiated by the master:
step 0: storing the current configuration of the field bus system as a known configuration,
step 1: following a restart of the bus system, allocating a standard address as subscriber address to the at least one bus subscriber,
step 2: checking whether the at least one bus subscriber is part of the known configuration, and
step 3: if this is the case, allocating an explicit subscriber address to the at least one bus subscriber,
step 4: checking whether the at least one bus subscriber still has the standard address, and
step 5: if this is the case, identifying the at least one bus subscriber and allocating an explicit subscriber address to the at least one bus subscriber.

2. The method according to claim 1, wherein steps 1 to 5 are performed for all respective bus subscribers present in the bus system.

3. The method according to claim 1, wherein steps 1 to 5 are performed by sending at least one request to be answered in binary form to the at least one bus subscriber.

4. The method according to claim 3, wherein the request to be answered in binary form is an instruction, linked to a condition, which is executed and at the same time answered positively by the at least one bus subscriber only if the condition is satisfied.

5. The method according to claim 4, wherein the request to be answered in binary form is an address change request linked to a condition, which, for the least one bus subscriber, results in allocation of a new subscriber address and in a positive response if the condition is satisfied.

6. The Method according to claim 4, wherein the condition is the presence of a particular identification feature in the at least one bus subscriber.

7. The method according to claim 4, wherein the condition or part of the condition is the association between the at least one bus subscriber and a particular manufacturer.

8. The method according to claim 4, wherein the condition or part of the condition is the association between the at least one bus subscriber and a particular function type.

9. The method according to claim 5, wherein in step 1 the at least one bus subscriber is sent an address change request with which the standard address is transmitted as new subscriber address and whose condition is always satisfied by the at least one bus subscriber.

10. The method according to claim 5, wherein as steps 2 and 3 the at least one bus subscriber is sent an address change request with which the explicit subscriber address is transmitted as new subscriber address and whose condition is the association between the at least one bus subscriber and a manufacturer and/or a function type, according to the known configuration.

11. The method according to claim 5, wherein the condition is the presence of a particular identification feature in the at least one bus subscriber, and wherein steps 2 and 3 the at least one bus subscriber is sent an address change request with which the explicit subscriber address is transmitted as new subscriber address and whose condition is the presence of an explicit identification number, known before the restart, in the bus subscriber.

12. The method according to claim 5, wherein in step 4 the at least one bus subscriber is sent an address change request whose condition is the presence of the standard address.

13. The method according to claim 5, wherein in step 5 the least one bus subscriber is sent an address change request whose condition is the association between the at least one bus subscriber and a manufacturer which is possible in the bus system and/or a function type which is possible in the bus system.

14. The method according to claim 13, wherein address change request in step 5 or with a further address change request sent to the at least one bus subscriber only in the event of a positive response an explicit subscriber address is sent as new subscriber address.

15. An arrangement for automatically configuring a bus system with a master and with at least one bus subscriber which is connected to the master via a field bus, wherein the master and the least one bus subscriber operable to perform the following steps initiated by the master:
step 0: storing the current configuration of the field bus system as a known configuration,
step 1: following a restart of the bus system, allocating a standard address as subscriber address to the at least one bus subscriber,
step 2: checking whether the at least one bus subscriber is part of the known configuration, and
step 3: if this is the case, allocating an explicit subscriber address to the at least one bus subscriber,
step 4: checking whether the at least one bus subscriber still has the standard address, and
step 5: if this is the case, identifying the at least one bus subscriber and allocating an explicit subscriber address to the at least one bus subscriber.

16. The method according to claim 5, wherein the condition or part of the condition is the association between the at least one bus subscriber and a particular manufacturer or a particular function type, wherein as steps 2 and 3 the at least one bus subscriber is sent an address change request with which the explicit subscriber address is transmitted as new subscriber address and whose condition is the association between the at least one bus subscriber and a manufacturer and/or a function type, according to the known configuration.

17. The method according to claim 5, wherein the condition or part of the condition is the association between the at least one bus subscriber and a particular manufacturer and a particular function type, wherein as steps 2 and 3 the at least one bus subscriber is sent an address change request with which the explicit subscriber address is transmitted as new subscriber address and whose condition is the association between the at least one bus subscriber and a manufacturer and/or a function type, according to the known configuration.

18. The method according to claim 5, wherein the condition or part of the condition is the association between the at least one bus subscriber and a particular manufacturer and a particular function type, wherein in step 5 the least one bus subscriber is sent an address change request whose condition is the association between the at least one bus subscriber and a manufacturer which is possible in the bus system and/or a function type which is possible in the bus system.

19. The method according to claim 5, wherein the condition or part of the condition is the association between the at least one bus subscriber and a particular manufacturer or a particular function type, wherein in step 5 the least one bus subscriber is sent an address change request whose condition is the association between the at least one bus subscriber and a manufacturer which is possible in the bus system and/or a function type which is possible in the bus system.

20. The method according to claim 1, wherein the field bus system is a LIN bus system.
